(19) United States
(12) Patent Application Publication
(10) Pub. No.: US 2018/0053184 A1
(43) Pub. Date: Feb. 22, 2018

(54) METHOD OF IDENTITY VERIFICATION DURING PAYMENT CARD PROCESSING

(71) Applicant: Christine Casey, Bay Shore, NY (US)

(72) Inventor: Christine Casey, Bay Shore, NY (US)

(21) Appl. No.: 15/242,586

(22) Filed: Aug. 21, 2016

(51) Int. Cl. G06Q 20/40; G06Q 20/34

(52) U.S. Cl. CPC G06Q 20/409; G06Q 20/34; G06Q 20/4014

(57) ABSTRACT

A method for identity verification during authorization of a payment card which employs a composite verification process at the time a card user having a payment card and who desires to make a purchase from a merchant provides information related to their payment card to the merchant. In this regard, the identity of the user can be verified prior to the completion of the authorization of the payment card. The composite verification process includes, upon card information being provided to a payment terminal, at least confirming that the payment terminal in use is connected to an electronic visual display that is capable of displaying an image, retrieving from the card information received a stored image of the owner and/or authorized user(s) of the payment card, and causing the stored image to be displayed on the connected electronic visual display.

### BACKGROUND OF THE INVENTION

### Field of the Invention

This invention relates generally to anti-fraud systems and methods and, more particularly, to a method for verifying a user of a payment card at the time a purchasing transaction is processed.

### Description of the Prior Art

The operation of a payment card as an implement for making payments by electronic funds transfer for a financial transaction, such as a purchase, is well established. While there exist many types of payment cards, it is generally recognized that credit cards, which allow a user to make purchases by drawing from a line of credit, and debit cards, which allow a user to make purchases by drawing directly from a bank account, are the most commonly used payment cards. Because of the convenience and other benefits offered by such payment cards, their use to make payments to merchants has become extremely common for purchases in all types of scenarios, including retail point of sale transactions, telephonic transactions, and online transactions.

While the convenience offered by various payment cards is generally acknowledged, existing mechanisms for payment card security are often unable to prevent the unauthorized use of credit cards and debit cards for fraudulent transactions. Such existing mechanisms, which often involve the physical security of the actual payment card, the privacy of the card number, and the security of the card data stored by the card magnetic strip, generally are unable to ensure the that the actual user of the card at the time the card is authorized is the actual owner of the card or some other rightful user. While additional security features, such as the inclusion of additional security numbers and/or a physical integrated circuit (i.e. a “chip”), have been added over time to reduce unauthorized use of cards, the impact of such features is still limited because they still do not allow a merchant to confirm that the user of a card at the time of card authorization is an authorized user. Indeed, it is personally known by the Inventor of the instant method that even if a payment card includes a chip, if the card data stored on the magnetic strip is duplicated fraudulently, a fraudulent payment card with a duplicated magnetic strip can be used at least once for a fraudulent transaction as long as the merchant with whom the fraudulent transaction is attempted does not require the use of a chip at the time the fraudulent payment card is used. Along these same lines, it is noted that the presence of a chip on a payment card does nothing the prevent the unauthorized use of the card for a fraudulent online transaction.

As such, a problem that still exists is that the current mechanisms for payment card security are presently unable to account for many common ways in which a payment card could be fraudulently used. Simply put, if a merchant is unable to verify the authenticity of a user of a payment card at the time the payment card is attempted to be authorized, there may not be a way to prevent the use of the payment card for a fraudulent transaction.

Thus, there remains a need for a method of identity verification during payment card processing that automatically selects and performs an identity verification step as a part of the authorization step of payment card processing. It would be helpful if such a method of identity verification during payment card processing included a plurality of potential identity verification steps that could be employed based on the capability of the payment terminal.

### SUMMARY OF THE INVENTION

A method for identity verification during authorization of a payment card that employs a composite verification process at the time a card user having a payment card and who desires to make a purchase from a merchant provides information related to their payment card to the merchant. In this regard, the identity of the user can be verified prior to the completion of the authorization of the payment card. The composite verification process includes, upon card information being provided to a payment terminal, confirming that the payment terminal in use is connected to an electronic visual display that is capable of displaying an image, retrieving from the card information received a stored image of the owner and/or authorized user(s) of the payment card, and causing the stored image to be displayed on the connected electronic visual display. This visual verification step allows the merchant to visually determine whether the card user is the owner and/or authorized user(s) of the payment card prior to the transmission of the card information and transaction details to an acquirer.

If the payment terminal is not connected to a suitable electronic visual display, the composite verification process proceeds to retrieve from the card information received electronic contact information of the owner and/or authorized user(s), transmit an electronic verification code only to the owner and/or authorized user(s) of the card, and require that the verification character string be keyed in in order to allow the merchant to proceed with transmitting card information and transaction details to the acquirer. This transmission verification step provides a fallback for payment terminals that do not have the capability to provide the visual verification step.

It is an object of this invention to provide a method of identity verification during payment card processing that automatically selects and performs an identity verification step as a part of the authorization step of payment card processing.

It is another object of this invention to provide a method of identity verification during payment card processing that includes a plurality of potential identity verification steps that could be employed based on the capability of the payment terminal.

These and other objects will be apparent to one of skill in the art.

### BRIEF DESCRIPTION OF THE DRAWINGS

FIG. 1 shows a block diagram of the operative elements of an authorization process during payment card processing in accordance with the prior art.

FIG. 2 shows an authorization process during payment card processing in accordance with the prior art.

FIG. 3 shows a block diagram of the operative elements of an authorization process that includes a composite verification process in accordance with the present invention.

FIG. 4A shows a first portion of a composite verification process for the authorization process during payment card processing in accordance with the present invention.

FIG. 4B shows a second portion of a composite verification process for the authorization process during payment card processing in accordance with the present invention.

### DETAILED DESCRIPTION OF THE INVENTION

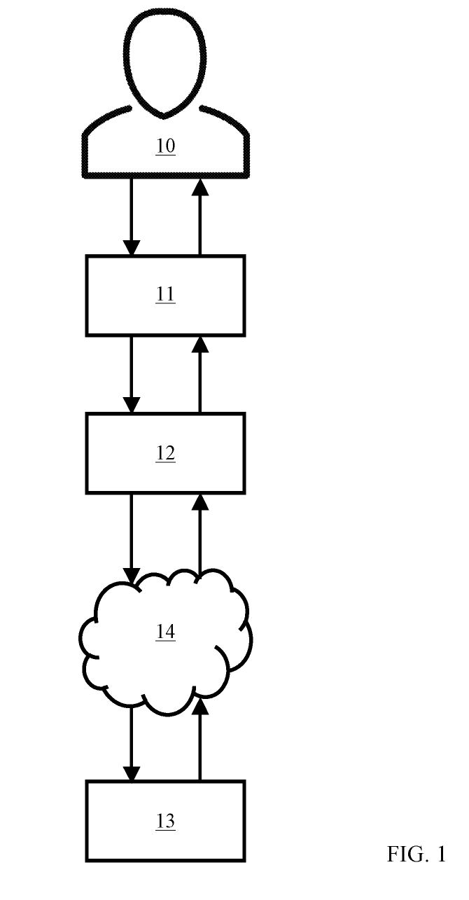

Referring now to the drawings and in particular FIG. 1, the processing of a payment card, such as a credit card or a debit card, generally begins with an authorization step. Generally, the authorization step serves to confirm that a payment card sought to be used for a transaction is valid and is otherwise eligible to be used for the transaction.

Accordingly, for a conventional purchase transaction, the authorization step typically involves a card user 10 as the party seeking to make a payment with a payment card in the purchase transaction, a merchant 11 as the party seeking to receive the payment from the card user 10 in the purchase transaction, an acquirer 12 (or acquiring bank) as the merchant's 11 financial institution to whom the payment funds are to be directed, an issuing bank 13 as the issuer of the payment card used by the card user 10 and from whom the payment funds are directed, and a card association network 14 that acts as an administrator between acquirer 12 and the issuing bank 13.

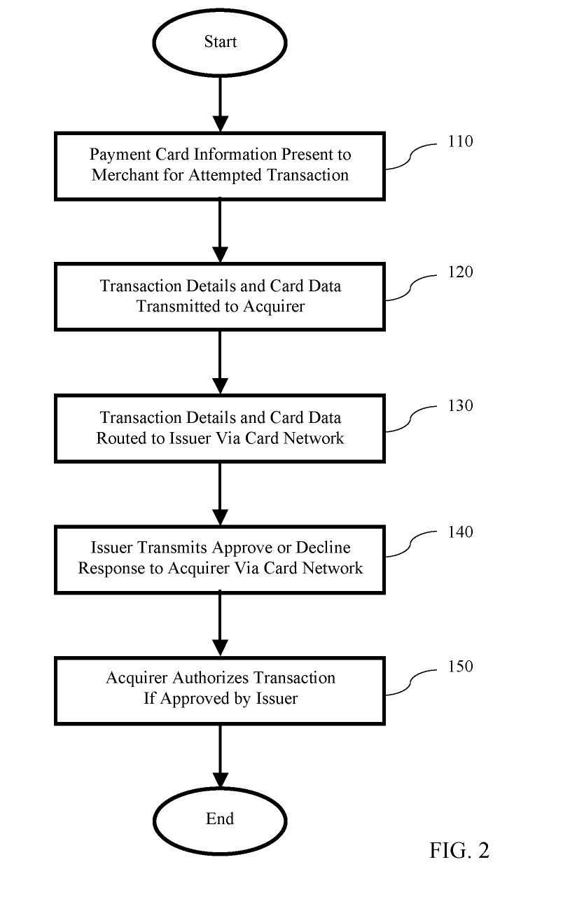

Referring now to FIG. 2, the authorization step commonly begins with a card user having a payment card and who desires to make a purchase from a merchant providing information related to their payment card to the merchant 110. This is often accomplished by the entry of identifying information from the card into a payment terminal, such as a credit card machine, reader, or software interface, controlled by the merchant. In a retail point of sale transaction scenario, where the user is present with the merchant, this is generally done by using a physical payment terminal to swipe a magnetic strip on the card or read a chip on the card. In a telephonic transaction scenario or an online transaction scenario, where the user is remote from the merchant, this is generally done by manually entering card numbers into a physical payment terminal or software interface.

Next, the merchant will typically transmit to the acquirer the card information along with details related to the transaction 120. The acquirer then forwards this information to the card association network to be routed the issuing bank 130. Once the issuing bank receives the card information and transaction details, it will then issue a response in which it approves or declines the transaction and then forwards this response to the card association network to be routed back to the acquirer 140. At this point, provided the issuing bank approved the transaction, the acquirer will typically authorize the transaction 150 and indicate that the merchant may complete the purchase with the card user.

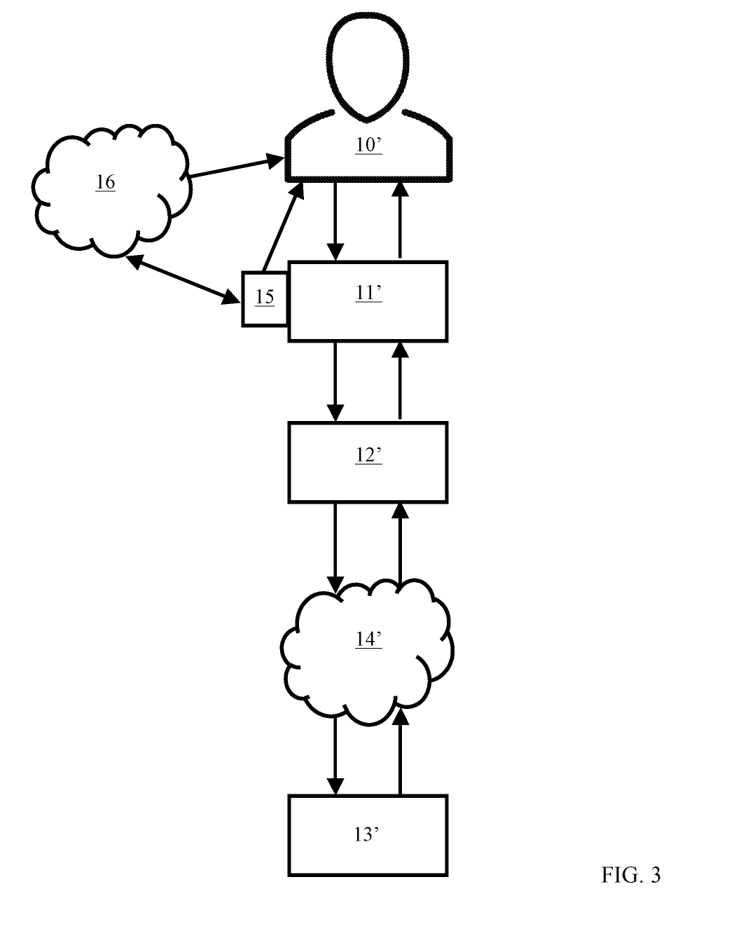

Referring now to FIG. 3, a method for identity verification during payment card processing operates during the authorization step of the processing of a payment card, such as a credit card or a debit card. In this regard, for a purchase transaction in which the method of identity verification during payment card processing is implemented, the authorization step will involve a card user 10′ as the party seeking to make a payment with a payment card in the purchase transaction, a merchant 11′ as the party seeking to receive the payment from the card user 10′ in the purchase transaction, an acquirer 12′ (or acquiring bank) as the merchant's 11′ financial institution to whom the payment funds are to be directed, an issuing bank 13′ as the issuer of the payment card used by the card user 10′ and from whom the payment funds are directed, a card association network 14′ that acts as an administrator between acquirer 12′ and the issuing bank 13′, and a composite verification module 15 that administrates the method for identity verification during payment card processing by way of a data connection to the merchant 11′ and a computer network, such as the Internet 16. In one embodiment, the composite verification module 15 defines a set of instructions embodied in software accessible to a processor in a merchant's 11′ payment terminal and that enable the payment terminal to perform a composite verification process detailed below.

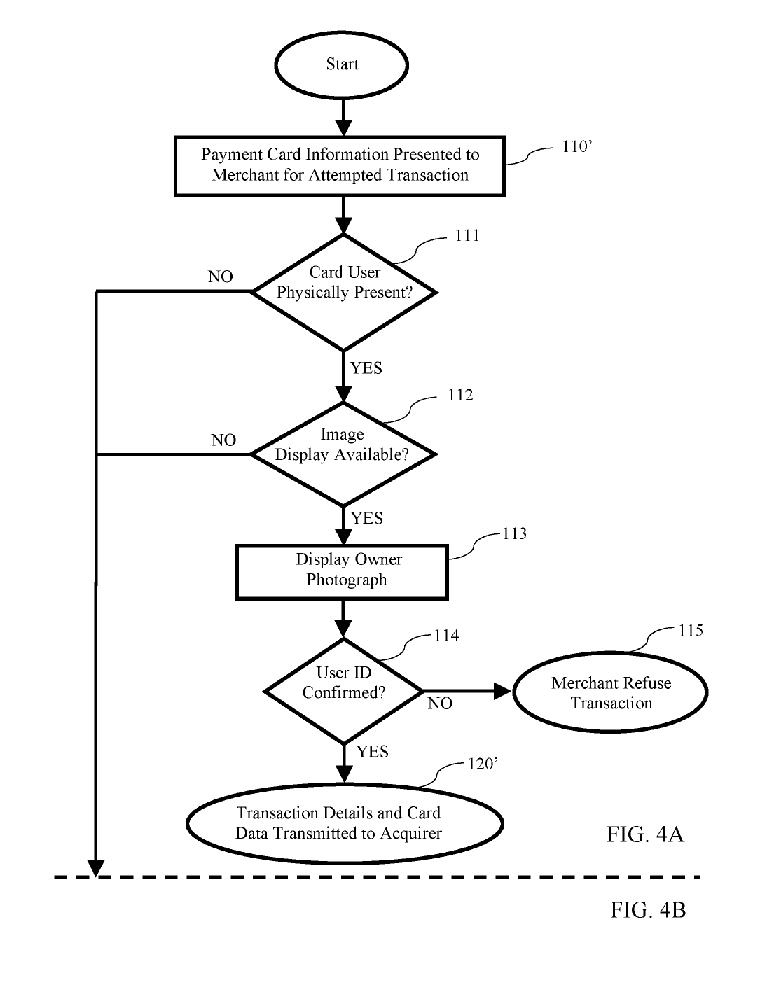

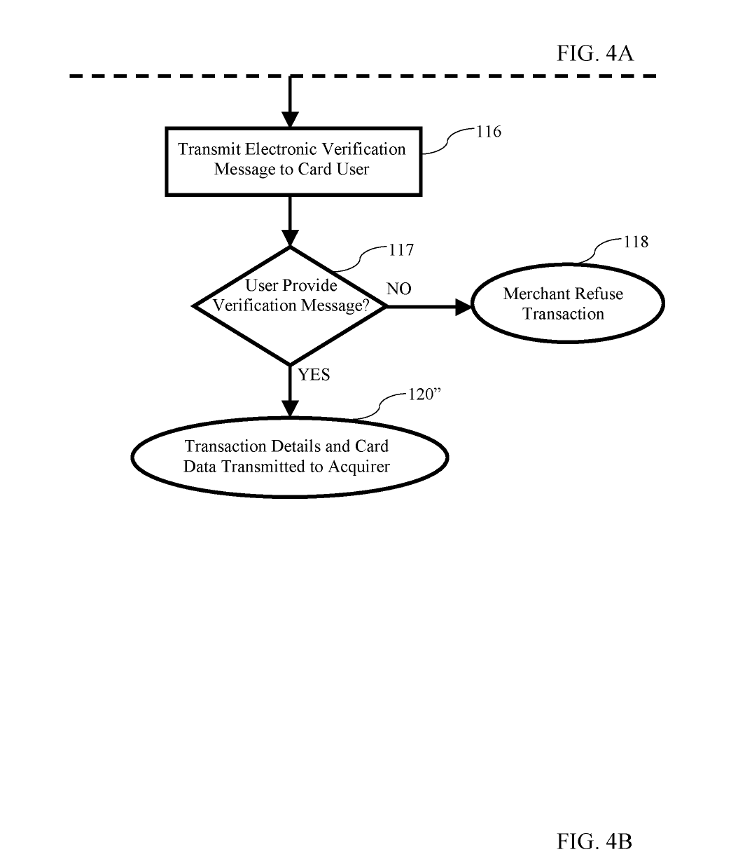

Referring now to FIGS. 4A and 4B, the composite verification process is advantageously implemented at the time a card user having a payment card and who desires to make a purchase from a merchant provides information related to their payment card to the merchant 110′. Instead of immediately transmitting to the acquirer the card information along with details related to the transaction 120′, the composite verification process includes first causing the payment terminal on which the card information is received to confirm, based on the manner in which the payment card is used, whether the user of the card is physically present 111. If the card information is provided to the payment terminal by way of a swipe of a magnetic strip or a read of a chip, it is confirmed that the user is present and the composite verification process proceeds to determine if the payment terminal in use is connected to an electronic visual display that is capable of displaying an image 112. If so, the composite verification process retrieves from the card information received a stored image of the owner and/or authorized user(s) of the payment card and causes the stored image to be displayed on the connected electronic visual display 113, thereby enabling the merchant to visually determine whether the card user is the owner and/or authorized user(s) of the payment card prior to the transmission of the card information and transaction details to the acquirer 114. With the image displayed, the composite verification process presents a menu on the payment terminal that allows the merchant to either proceed with transmitting the card information and transaction details to the acquirer 120′ or refuse the transaction 115.

If the payment terminal is not connected to (or otherwise include) a suitable electronic visual display, the composite verification process proceeds to retrieve from the card information received electronic contact information, such as a text message number or an email address, for the owner and/or authorized user(s) of the card. Using the contact information, a unique, randomly generated one time use electronic verification character string is transmitted only to the owner and/or authorized user(s) of the card. The composite verification process then presents a menu on the payment terminal that requires this verification character string to be keyed in. Then, if the keyed verification character string is correct, the composite verification process presents a menu on the payment terminal that allows the merchant to proceed with transmitting card information and transaction details to the acquirer 120′. If the keyed verification message is incorrect or not provided, however, the composite verification process causes the payment terminal to refuse the transaction 118.

It is contemplated that the verification character string may be a defined combination of numbers that would be acceptable for verification for a predetermined duration of time, such as five (5) minutes. Advantageously, in such an embodiment, most existing payment terminals would be able to receive the verification character string in the substantially same manner that conventional card numbers (such as verification codes or expiration dates) are entered.

If it is determined that the card user is not physically present (because the card was not swiped or read), the composite verification process may terminate and allow the authorization step to proceed in the conventional manner. It is contemplated, however, that in some embodiments, the composite verification process may attempt to perform verification through the verification character string step. In such an embodiment, however, the electronic contact information would have to be retrieved from the issuer or card network association prior to the performance of the step. For example, for a telephonic transaction, a card user would be required to tell the merchant verbally the verification character string, with the merchant keying in the characters. Similarly, for an online transaction, the composite verification process would in one embodiment provide a menu in which the verification character string would be entered through a software interface. It is noted, however, that the merchant would not otherwise have access to the character string and thus would not be able to complete the transaction without being told the verification character string by the card user.

It is appreciated that payment cards built in accordance with the present disclosure must include stored data related to an image of the card owner and/or authorized user(s) and contact information that enables the transmission of an electronic message to the owner and/or authorized user(s). It is contemplated, however, that such payment cards may include either an actual image file or a link/pointer to an image file stored in some specified networked location. In such a scenario, the payment card may only include a link to a social media account or government agency where an image file of the owner and/or authorized user(s) may be stored.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for identity verification during authorization of a payment card, comprising the steps of:
providing a payment card having at least one authorized user and predetermined card information associated therewith, wherein said card information is stored as data in an electronic format on a medium integral with the payment card;
upon the payment card being presented by a card user for use to make a payment for a transaction, receiving by a payment terminal the card information data, wherein said card information data includes a card identifier and an image of the at least one authorized user;
causing by the payment terminal the image to be displayed on an electronic visual display integral with the payment terminal, thereby enabling a visual comparison of the card user and the image of the at least one authorized user.

2. The method of claim 1, additionally comprising the step of providing by the payment terminal an interface which allows the termination of the transaction prior to a transmission of authorization data related to the payment card to an acquirer.

3. The method of claim 1, wherein said medium defines at least one of a magnetic strip and an integrated circuit.

4. The method of claim 1, wherein said medium defines an integrated circuit.

5. A method for identity verification during authorization of a payment card, comprising the steps of:
providing a payment card having at least one authorized user and predetermined card information associated therewith, wherein said card information is stored as data in an electronic format on a medium integral with the payment card;
upon the payment card being presented by a card user for use to make a payment for a transaction, receiving by a payment terminal the card information data, wherein said card information data includes a card identifier, an image of the at least one authorized user, and electronic contact information for the at least one authorized user;
determining whether the payment terminal is connected to an electronic visual display;
if payment terminal is connected to the electronic visual display, causing by the payment terminal the image to be displayed on an electronic visual display integral with the payment terminal, thereby enabling a visual comparison of the card user and the image of the at least one authorized user.

6. The method of claim 5, additionally comprising the steps of:
electronically transmitting by the payment terminal an electronic verification code to the electronic contact information if the payment terminal is not connected to the electronic visual display;
upon transmitting the verification code, providing by the payment terminal an interface requires the entry of the verification code prior to a transmission of authorization data related to the payment card to an acquirer.

7. The method of claim 7, wherein said electronic contact information defines an electronic mail address.

8. The method of claim 6, wherein said electronic contact information defines an messaging service code.

9. The method of claim 8, wherein said electronic contact information defines at least one of a telephone number and a short code number.

10. The method of claim 6, wherein said electronic contact information defines a wireless data network address.

11. The method of claim 5, additionally comprising the step of providing by the payment terminal an interface which allows the termination of the transaction prior to a transmission of authorization data related to the payment card to an acquirer upon causing the image to be displayed.

12. The method of claim 5, wherein said medium defines at least one of a magnetic strip and an integrated circuit.

13. The method of claim 5, wherein said medium defines an integrated circuit.

14. A method for identity verification during authorization of a payment card, comprising the steps of:
providing a payment card having at least one authorized user and predetermined card information associated therewith, wherein said card information is stored as data in an electronic format on a medium integral with the payment card;
upon the payment card being presented by a card user for use to make a payment for a transaction, receiving by a payment terminal the card information data, wherein said card information data includes a card identifier, an image of the at least one authorized user, and electronic contact information for the at least one authorized user;
determining whether the payment terminal is connected to an electronic visual display;
if the payment terminal is connected to the electronic visual display, causing by the payment terminal the image to be displayed on an electronic visual display integral with the payment terminal, thereby enabling a visual comparison of the card user and the image of the at least one authorized user;
electronically transmitting by the payment terminal an electronic verification code to the electronic contact information if the payment terminal is not connected to the electronic visual display; and
upon transmitting the verification code, providing by the payment terminal an interface requires the entry of the verification code prior to a transmission of authorization data related to the payment card to an acquirer.

15. The method of claim 14, additionally comprising the step of providing by the payment terminal an interface which allows the termination of the transaction prior to a transmission of authorization data related to the payment card to an acquirer upon causing the image to be displayed.

16. The method of claim 14, wherein said medium defines at least one of a magnetic strip and an integrated circuit.

17. The method of claim 14, wherein said medium defines an integrated circuit.

18. The method of claim 14, wherein said electronic contact information defines an electronic mail address.

19. The method of claim 14, wherein said electronic contact information defines an messaging service code.

20. The method of claim 14, wherein said electronic contact information defines a wireless data network address.
